(19) United States
(12) Patent Application Publication
(10) Pub. No.: US 2005/0217942 A1
(43) Pub. Date: Oct. 6, 2005

(54) Hoisting system for elevator

(75) Inventor: Motohisa Yamamura, Mie (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Nabtesco Corporation

(21) Appl. No.: 11/024,102

(22) Filed: Dec. 28, 2004

Related U.S. Application Data
(63) Continuation of application No. PCT/JP03/08368, filed on Jul. 1, 2003.

(30) Foreign Application Priority Data
Jul. 3, 2002 (JP) 2002-195299

(51) Int. Cl. B66B 11/08

(52) U.S. Cl. 187/266

(57) ABSTRACT

A hoisting system for an elevator which can reduce the weight of a traction type elevator system by including a pressing roller for pressing the rope against the outer circumferential surface of the sheave, the pressing roller being rotatably supported on a non-rotational member and having a pressing means for pressing the roller against the rope, the pressing roller in its outer circumference having an arc-like groove which is brought into engagement with the rope, the outer circumference of the pressing roller being made of an elastic material, the pressing roller being constituted by at least a pair of pressing rollers which are disposed substantially symmetrically relative to a rotating center of the sheave, and the pressing roller being movable relative to the rope and including a belt wrapped between the pair of pressing rollers, whereby the pair of pressing rollers press the rope against the outer circumferential surface of the sheave via the belt wrapped between the pair of pressing rollers.

### TECHNICAL FIELD

The present invention relates to a hosing system for a traction type elevator. More particularly, the invention relates to a hoisting system for an elevator which includes a sheave connected to a motor for rotation a rope wrapped around an outer circumferential surface of the sheave for lifting up and down an elevator car.

### BACKGROUND ART

A hoisting system for a conventional traction type elevator will be described in FIG. 5. In FIG. 5, a sheave 1 is connected to a motor (not shown) for rotation. A rope 2 is wrapped around an outer circumferential surface of the sheave 1. An elevator car 3 is connected to a suspending portion of the rope 2. A counterweight 4 is connected to the other suspending portion of the rope 2.

There is a case where the sheave 1 is rotated by the motor via reduction gears (not shown).

When the motor is driven to rotate, the elevator car 3 can be lifted up and down through the rotation of the sheave 1 and vertical movements of the rope 2.

Then, the rotational driving force of the motor is transmitted to the rope 2 by making use of only a frictional force between the outer circumferential surface of the sheave 1 and an circumferential surface of the rope 2. The frictional force is obtained from friction coefficients of the sheave 1 and the rope 2 and tension exerted by the elevator car 3 and the counterweight 4.

However, as has been described above, in the hoisting system for the conventional traction type elevator, since the rotational driving force of the motor is transmitted to the rope 2 based only on the frictional force between the outer circumferential surface of the sheave 1 and the circumferential surface of the rope 2, in order to prevent the transmission of no rotational driving force of the motor to the rope 2 due to slippage occurring between the sheave 1 and the rope 2, the weights of the elevator car 3 and the counterweight 4 were increased more than needed. Consequently, it has been difficult to reduce the weight of the traction type elevator system.

The invention was made in view of the above situation, and an object thereof is to provide a hoisting system for an elevator which can reduce the weight of a traction type elevator system.

### DISCLOSURE OF THE INVENTION

With a view to attaining the object, according to the invention, there is provided a hoisting system for an elevator including a sheave connected to a motor for rotation and a rope wrapped around an outer circumferential surface of the sheave so as to lift up and down an elevator car, the hoisting system being characterized by having a pressing roller for pressing the rope against the outer circumferential surface of the sheave. Namely, since the frictional force between the outer circumferential surface of the sheave and the circumferential surface of the rope is increased by the pressing roller, the weights of the elevator car 3 and the counterweight 4 can be reduced. Consequently, there can be provided the hoisting system for an elevator which can reduce the weight of a traction type elevator system.

In addition, the invention is characterized in that the pressing roller is rotatably supported on a non-rotational member and is characterized by having a pressing means for pressing the roller against the rope. Consequently, the rotation of the pressing roller becomes smooth, and a strong pressing force against the rope and the sheave can be generated.

Additionally, the invention is characterized in that the pressing roller has in its outer circumference an arc-like groove which is brought into engagement with the rope. Consequently, the contact area of the pressing roller to the rope is increased, and the frictional force between the pressing roller and the rope can be increased.

In addition, the invention is characterized in that the outer circumference of the pressing roller is made of an elastic material. Namely, the outer circumference of the pressing roller can be deformed into an arc by following the circumference of the rope. Consequently, the contact area of the pressing roller to the rope is increased, and the frictional force between the pressing roller and the rope can be increased.

Additionally, the invention is characterized in that the pressing roller is made up of at least a pair of pressing rollers which are disposed substantially symmetrically relative to a rotating center of the sheave. Consequently, when compared with a case where a single pressing roller is provided, the frictional force between the pressing rollers and the rope can be increased.

In addition, the invention is characterized in that the pressing roller is movable relative to the rope. Consequently, the invention can deal with ropes of various rope diameters.

Additionally, the invention is characterized by including a belt wrapped between the pair of pressing rollers, whereby the pair of pressing rollers press the rope against the outer circumferential surface of the sheave via the belt wrapped between the pair of pressing rollers. Consequently, the contact area of the pressing rollers to the rope via the belt can be increased, whereby the frictional force between the rollers and the rope via the belt can be increased.

### BRIEF DESCRIPTION OF THE DRAWINGS

FIG. 1 is a drawing showing a first embodiment of the invention.

FIG. 2 is a detailed cross-sectional view of a pressing roller portion according to the first embodiment of the invention.

FIG. 3 is a drawing showing another example of a pressing roller according to the invention.

FIG. 4 is a drawing showing a second embodiment of the invention.

FIG. 5 is a drawing showing a hoisting system for a conventional traction type elevator.

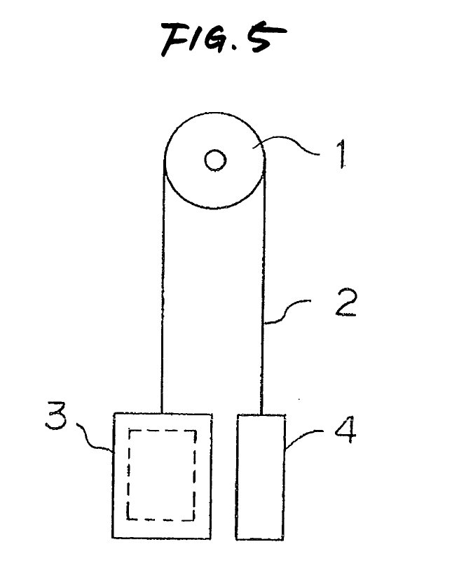

### BEST MODE FOR CARRYING OUT THE INVENTION

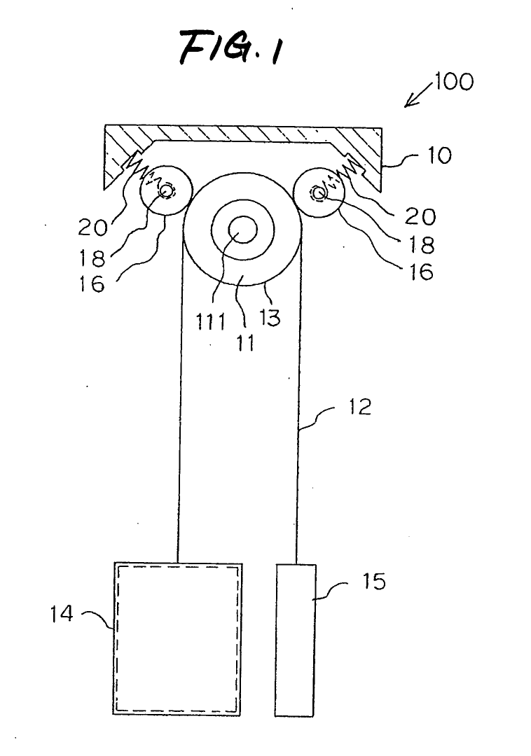

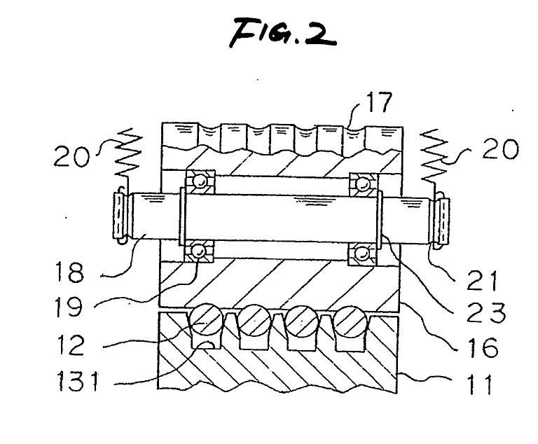

A first embodiment of the invention will be described below based on the drawings. FIGS. 1 and 2, reference numeral 100 denotes a hoisting system for an elevator which is applied to a traction type elevator system. A fixing member 10 is mounted on a stationary location of the traction type elevator system. The rotation of a motor (not shown) is transmitted to an input portion 111 of a sheave 11 via reduction gears (not shown). Namely, the sheave 11 is connected to the motor for rotation.

A rope 12 is wrapped around a groove portion 131 in an outer circumferential surface 13 of the sheave 11 so as to lift up and down an elevator car 14. The elevator car 14 is connected to a suspending portion of the rope 12. A counterweight 15 is connected to the other suspending portion of the rope 12. A pair of pressing rollers 16 are disposed substantially symmetrically relative to a rotating center of the sheave 11, so that the rope 12 is pressed against the outer circumferential surface 13 of the sheave 11. To be specific, the pair of pressing rollers 16 are disposed substantially symmetrically in a lateral direction relative to a vertical including the rotating center of the sheave 11. The pair of pressing rollers 16 has in the outer circumference thereof an arc-like groove 17 which is brought into engagement with the rope. Each pressing roller 16 is rotatably supported on a shaft 18 (a non-rotational member) via a pair of bearings 19.

A spring 20 (a pressing means) presses each pressing roller 16 against the rope 12. Since each spring 20 can expand and contract, each pressing roller is movable relative to the rope.

In addition, the pressing force of each pressing roller 16 against the rope 12 can be adjusted appropriately by allowing a fixing portion where the pressing means (the spring 20) is fixed to the fixing member 10 to move relative to the fixing member 10. the pressing force of each pressing roller 16 against the rope 12 can be adjusted appropriately by setting an appropriate spring constant for the spring 20.

An end of the spring 20 is supported on the fixing member 10 and the other end thereof is connected to a circumferential groove 21 in the shaft 18. Shaft snap rings 23 are used not only to locate the pair of bearings 19 but also to prevent the dislocation thereof.

Next, the operation of the first embodiment of the invention will be described.

The pair of pressing rollers 16 are pressing the rope 12 against the outer circumferential surface of the sheave 11 via the springs 20 at all times. Namely, the frictional force between the outer circumferential surface of the sheave 11 and the circumferential surface of the rope 12 is increased by the pair of pressing rollers 16. Consequently, the weights of the elevator car 3 and the counterweight 4 can be reduced.

(Another Example of Pressing Rollers)

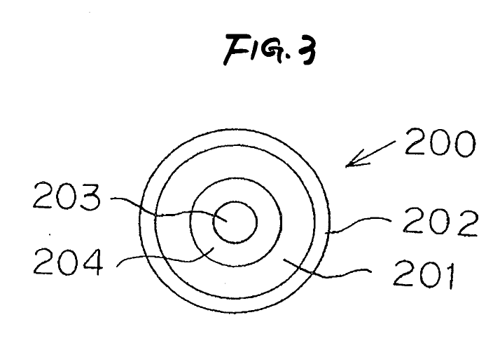

Another example of a pair of pressing rollers according to the invention will be described based on the drawing. In FIG. 3, in each pressing roller 200, a cylindrical elastic body 202 of a rubber or silicone is held around an outer circumference of a metallic roller main body 201. Similar to the pressing roller of the first embodiment, the roller main body 201 is rotatably supported on a shaft 203 (a non-rotational member) via a pair of bearings 204.

Even in the event that no arc-like groove is formed in the outer circumference of the pressing roller 200, as in the case with the first embodiment, the outer circumference of the pressing roller 200 can be deformed into an arc by following the circumference of the rope 12. Consequently, the contact area (contact resistance) of the pressing roller 200 to the rope 12 is increased, whereby the frictional force between the pressing roller 200 and the rope 12 can be increased (a greater frictional resistance).

It is not necessary that the elastic body 202 is separately held on the outer circumference of the pressing roller 200, but the roller main body 201 itself may form a cylindrical elastic body.

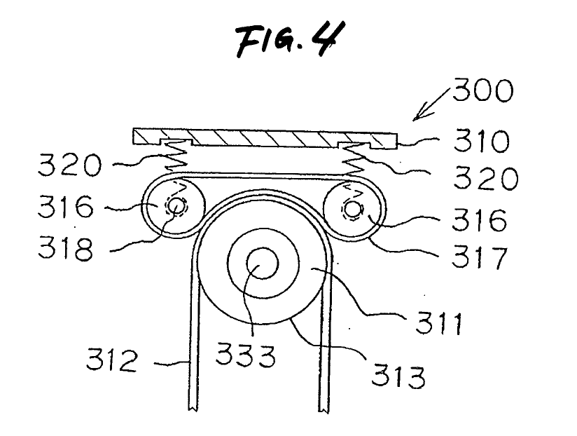

Next, a second embodiment of the invention will be described based on the drawing. In FIG. 4, reference numeral 300 denotes a hoisting system for an elevator which is applied to a traction type elevator system. A fixing member 310 is mounted on a stationary location of the traction type elevator system. The rotation of a motor (not shown) is transmitted to an input portion 333 of a sheave 311 via reduction gears (not shown). Namely, the sheave 311 is connected to the motor for rotation.

A rope 312 is wrapped around a groove portion (not shown) in an outer circumferential surface 313 of the sheave 311 so as to lift up and down an elevator car (not shown). The elevator car is connected to a suspending portion of the rope 312. A counterweight (not shown) is connected to the other suspending portion of the rope 312. A pair of pressing rollers 316 are disposed substantially symmetrically relative to a rotating center of the sheave 311, so that the rope 312 is pressed against the outer circumferential surface 313 of the sheave 311. To be specific, the pair of pressing rollers 316 are disposed substantially symmetrically in a lateral direction relative to a vertical including the rotating center of the sheave 311. A belt 317 is wrapped around outer circumferential surfaces of the pair of pressing rollers 316. The pair of pressing rollers 316 press the rope 312 against the outer circumferential surface of the sheave 311 via the belt 317.

As in the case with the first embodiment, each pressing roller 316 is rotatably supported on a shaft 318 (a non-rotational member) via a pair of bearings (not shown).

A spring 320 (a pressing means) presses each pressing roller 316 against the rope 312. Since each spring 320 can expand and contract, each pressing roller 316 is movable relative to the rope 312.

An end of the spring 320 is supported on the fixing member 310 and the other end thereof is connected to a circumferential groove (not shown) in the shaft 318.

Next, the operation of the second embodiment of the invention will be described.

In FIG. 4, the pair of pressing rollers 316 are pressing the rope 312 against the outer circumferential surface of the sheave 311 via the belt 317 by the springs 320 at all times. Namely, the contact area (contact resistance) of the pressing rollers 316 to the rope 312 via the belt 317 is increased, whereby the frictional force between the pressing rollers 316 and the rope 312 via the belt 317 can be increased (a greater frictional resistance).

Note that while in the invention, the roping mode has been described as a 1-to-1 mode, the invention is not limited to the 1-to-1 roping mode.

### INDUSTRIAL APPLICABILITY

As has been described heretofore, according to a first aspect of the invention, there can be provided the hoisting system for an elevator which can reduce the weight of a traction type elevator system.

According to a second aspect of the invention, the rotation of the pressing roller becomes smooth, and a strong pressing force against the rope and the sheave can be generated.

According to a third aspect of the invention, the contact area of the pressing roller to the rope is increased, and the frictional force between the pressing roller and the rope can be increased.

According to a fourth aspect of the invention, the contact area of the pressing roller to the rope is increased, and the frictional force between the pressing roller and the rope can be increased.

According to a fifth aspect of the invention, when compared with a case where a single pressing roller is provided, the frictional force between the pressing rollers and the rope can be increased.

According to a sixth aspect of the invention, the invention can deal with ropes of various rope diameters.

According to a seventh aspect of the invention, the contact area of the pressing rollers to the rope via the belt can be increased, whereby the frictional force between the rollers and the rope via the belt can be increased.

1. A hoisting system for an elevator comprising a sheave connected to a motor for rotation and a rope wrapped around an outer circumferential surface of the sheave so as to lift up and down an elevator car, the hoisting system being characterized by having a pressing roller for pressing the rope against the outer circumferential surface of the sheave.

2. A hoisting system for an elevator as set forth in claim 1, characterized in that the pressing roller is rotatably supported on a non-rotational member and characterized by having a pressing means for pressing the roller against the rope.

3. A hoisting system for an elevator as set forth in claim 1, characterized in that the pressing roller has in its outer circumference an arc-like groove which is brought into engagement with the rope.

4. A hoisting system for an elevator as set forth in claim 1, characterized in that the outer circumference of the pressing roller is made of an elastic material.

5. A hoisting system for an elevator as set forth in claim 1, characterized in that the pressing roller is made up of at least a pair of pressing rollers which are disposed substantially symmetrically relative to a rotating center of the sheave.

6. A hoisting system for an elevator as set forth in claim 1, characterized in that the pressing roller is movable relative to the rope.

7. A hoisting system for an elevator as set forth in claim 5, characterized by comprising a belt wrapped between the pair of pressing rollers, whereby the pair of pressing rollers press the rope against the outer circumferential surface of the sheave via the belt wrapped between the pair of pressing rollers.
